(19) United States
(12) Patent Application Publication
(10) Pub. No.: US 2022/0079371 A1
(43) Pub. Date: Mar. 17, 2022

(54) STEAM COOKING APPARATUS AND STEAM COOKING METHOD

(71) Applicant: TEAM YOUNG TECHNOLOGY CO., LTD., Taoyuan City (TW)

(72) Inventors: Pin-Chun Huang, Taoyuan City (TW); Dy-Cheng Wang, Taoyuan City (TW); Chia-Chi Chang, Taoyuan City (TW)

(73) Assignee: TEAM YOUNG TECHNOLOGY CO., LTD., Taoyuan City (TW)

(21) Appl. No.: 17/433,241

(22) PCT Filed: Mar. 19, 2020
(86) PCT No.: PCT/CN2020/080206

§ 371 Date: Aug. 24, 2021

(30) Foreign Application Priority Data
Mar. 21, 2019 (CN) 201910215662.3

(51) Int. Cl. A47J 27/04; A23L 5/10

(52) U.S. Cl. CPC A47J 27/04; A23V 2002/00; A47J 2027/043; A23L 5/13

(57) ABSTRACT

Disclosed are a steam cooking apparatus (1) and a steam cooking method. The steam cooking apparatus (1) includes a food ingredient containing chamber (10) for containing a food ingredient (11) and having a normal atmospheric pressure; a saturated vapor generating device (20) having a vapor chamber (21) and configured to generate and accumulate high-pressure saturated vapor with a pressure higher than the normal atmospheric pressure; a saturated vapor spraying device (30) communicating with the vapor chamber (21) and having an outlet communicating with the food ingredient containing chamber (10) for releasing and spraying the high-pressure saturated vapor onto the food ingredient (11); when the released and sprayed saturated vapor reaches a surface of the food ingredient (11), the released and sprayed saturated vapor stays at a point of saturated vapor and releases latent heat to the food ingredient (11) and is transformed from the point of saturated vapor to a point of saturated liquid; and a water vapor discharge device (40). When the saturated vapor reaches the point of saturated liquid due to the releasing of the latent heat, the saturated vapor is transformed into a water vapor mixture, and the water vapor discharge device (40) discharges the water vapor mixture from the food ingredient containing chamber (10). As such, an optimum cooking effect may be obtained.

### TECHNICAL FIELD

The invention relates to a food steam cooking apparatus and a food steam cooking method, and particularly to a steam cooking apparatus and a steam cooking method for efficiently steam cooking food by applying latent heat of vapor.

### DESCRIPTION OF RELATED ART

There are roughly three types of steam cooking equipment currently on the market. One is to utilize normal atmospheric pressure vapor, e.g., common electronic pots, electric steamers, steam ovens, “energy-saving circulating steamer” provided in Chinese patent no. CN202681613U, and so on, which merely takes advantage of circulation and energy saving features of water vapor and applies a gas pumper to generate kinetic energy. In this type of equipment, water is heated to be above a point of saturated liquid to generate steam; due to low pressure differential and thermal convection, the steam is in contact with food, and heat energy in the steam is transmitted to the food.

However, in this type of equipment, after the water is heated into the steam, most of the steam contacts the food before the steam reaches a point of saturated vapor, and the amount of latent heat of the steam cannot reach the maximum value. Besides, few heat energy of the saturated vapor may be absorbed by water molecules in the steam; even if part of the heat energy is absorbed by the food, the latent heat is not significantly released because the water vapor may quickly return to the point of saturated liquid, and a water film may be formed on a surface of the food after the heat energy is partially absorbed by the food, and the subsequently applied heat energy heats and vaporizes the water film and is not applied to the food. Therefore, the overall thermal efficiency is insufficient, the cooking speed is low, and most of the heat energy is wasted on heating the condensed water film or the steam whose latent heat is released. When large food ingredients are being steam cooked, the cooking time is excessively long, which causes the food ingredients to be tough and overcooked.

The second type of steam cooking equipment is a steam roasting machine that utilizes superheated vapor, such as a superheated vapor oven, which heats, vaporizes, and dries the surface of the food ingredients due to the relatively high temperature of the superheated vapor. For instance, the Chinese patent no. CN105078219B “ultra-high temperature continuous steam roasting machine” and the U.S. patent publication no. US20070227364A1 “steam cooker” both aim to achieve the purpose of “steam roasting” by applying the superheated vapor.

However, even though the superheated vapor oven or the like may heat the steam to a temperature (e.g., 350° C.) at or above the point of saturated vapor to become the superheated vapor, the steam cannot be easily controlled if the steam is in the superheated vapor state. When the superheated vapor is applied to the food ingredients, the surfaces of the food ingredients may be burned. Hence, the superheated vapor is suitable for roasting rather than steam cooking fish or the like. Even if the temperature of the superheated vapor may be reduced to a temperature close to the point of saturated vapor according to the related art, e.g., the aforesaid U.S. patent publication, the water content of the saturated vapor converted from the superheated vapor is low, which is still not conducive to steam cooking. This is because the superheated vapor and liquid water cannot coexist in the state of thermal equilibrium. Before the energy loss of the superheated vapor reaches a condensation point (i.e., the point of saturated vapor), the superheated vapor exists in a gas state and fails to release the latent heat. Although the heat energy of the superheated vapor in the superheated state is partly released to the moisture on the surface of the food ingredients, as long as the evaporation is greater than the condensation in the dynamic equilibrium state, the moisture on the surface of the food ingredients is vaporized and taken away, and the surface is then dried.

The third type of steam cooking equipment is a high-pressure cooker or the like, wherein the steam is generated under high pressure to obtain a high temperature greater than a saturated vapor temperature at a normal atmospheric pressure, so that the food ingredients may be heated at a relatively high temperature. However, similar to a steamer, the high-pressure cooker is being operated by heating water into water vapor and raising the temperature of the water vapor under high pressure, and the food ingredients have been heated during the process of raising the temperature. Hence, the heat energy is mostly applied to heat the water or water in the water vapor (a mixture of water and water vapor), and the food ingredients may be heated by the mixture of water and water vapor which has not yet reached a point of saturated liquid. As such, the effect of fully applying the latent heat of the saturated vapor to the food ingredients cannot be accomplished. Moreover, during the cooking process, a food ingredient containing chamber is in a high-pressure state; inappropriate opening or closing the food ingredient containing chamber may lead to danger.

### SUMMARY

In view of the above, the invention is to provide an apparatus and a method that may fully utilize latent heat of saturated vapor to steam cook food ingredients, especially a steam cooking apparatus and a steam cooking method that may exert benefits of the latent heat of the saturated vapor under normal atmospheric pressure.

In order to achieve one or a portion of or all of the objects or other objects, an embodiment of the invention provides a steam cooking apparatus that includes:

a food ingredient containing chamber, configured to store a food ingredient and having a normal atmospheric pressure;

a saturated vapor generating device, having a vapor chamber and configured to generate and accumulate high-pressure saturated vapor with a pressure greater than the normal atmospheric pressure in the vapor chamber;

a saturated vapor spraying device, communicating with the vapor chamber and having an outlet communicating with the food ingredient containing chamber for releasing and spraying the high-pressure saturated vapor to the food ingredient, wherein when the released and sprayed saturated vapor reaches a surface of the food ingredient, the released and sprayed saturated vapor stays at a point of saturated vapor, and latent heat is released to the food ingredient by the released and sprayed saturated vapor transformed from the point of saturated vapor to a point of saturated liquid, so that the food ingredient is heated by latent heat released from the released and sprayed saturated vapor; and

a water vapor discharge device, configured to discharge a water vapor mixture from the food ingredient containing chamber, so that the released and sprayed saturated vapor is continuously applied to the food ingredient, and that the food ingredient is continuously heated by the latent heat released from the point of saturated vapor to the point of saturated liquid, wherein the saturated vapor is transformed into the water vapor mixture when the saturated vapor releases the latent heat and reaches the point of saturated liquid, and the water vapor mixture moves toward the water vapor discharge device,

wherein a release amount of the high-pressure saturated vapor and a discharge amount of the water vapor mixture are controlled, so that an ambient temperature of the food ingredient containing chamber is maintained to be greater than or equal to a saturated vapor temperature at the normal atmospheric pressure,

wherein the saturated vapor generating device further includes a first water tank located in the vapor chamber and a temperature controlling heater heating the first water tank, so that the vapor chamber has the high-pressure saturated vapor having a saturated vapor temperature corresponding to the high pressure,

wherein the steam cooking apparatus further includes a heat recycling device having a second water tank for accommodating water and a water vapor mixture discharge tube in the second water tank, wherein the water vapor mixture discharge tube communicates with the water vapor discharge device, so that heat energy of the discharged water vapor mixture is recycled into the water in the second water tank,

wherein the heat recycling device further includes a pressurized pump configured to pressurize the water in the second water tank and transfer to the saturated vapor generating device.

In order to achieve one or a portion of or all of the objects or other objects, an embodiment of the invention provides a steam cooking method that includes:

providing a food ingredient containing chamber configured to store a food ingredient and having a normal atmospheric pressure;

performing a step of generating high-pressure saturated vapor and accumulating the high-pressure saturated vapor with a pressure greater than the normal atmospheric pressure in a vapor chamber;

performing a steam cooking step to release the high-pressure saturated vapor from the vapor chamber and spray the high-pressure saturated vapor to the food ingredient, wherein when the released and sprayed saturated vapor reaches a surface of the food ingredient, the released and sprayed saturated vapor stays at a point of saturated vapor, and latent heat is released to the food ingredient by the released and sprayed saturated vapor transformed from the point of saturated vapor to a point of saturated liquid, so that the food ingredient is heated by latent heat released from the released and sprayed saturated vapor; and

performing a water vapor discharge step to discharge a water vapor mixture from the food ingredient containing chamber by a water vapor discharge device, wherein the saturated vapor is transformed into the water vapor mixture when the released and sprayed saturated vapor releases the latent heat and reaches the point of saturated liquid from the point of saturated vapor, and the water vapor mixture moves toward the water vapor discharge device, so that the released and sprayed saturated vapor is continuously applied to the food ingredient, and that the food ingredient is continuously heated by the latent heat released from the point of saturated vapor to the point of saturated liquid.

Here, in the steam cooking apparatus and the steam cooking method provided in the invention, a release amount of the high-pressure saturated vapor and a discharge amount of the water vapor mixture are controlled, so that an ambient temperature of the food ingredient containing chamber is maintained to be greater than or equal to a saturated vapor temperature at the normal atmospheric pressure.

Here, the step of generating the high-pressure saturated vapor further includes heating a first water tank located in the vapor chamber, so that the vapor chamber has the high-pressure saturated vapor having a saturated vapor temperature corresponding to the high pressure.

Here, the water vapor discharge step further includes a step of recycling heat energy of the water vapor mixture into water in a second water tank through having the water vapor mixture flow through the second water tank containing the water, and the water vapor mixture is not mixed with the water in the second water tank.

According to the apparatus and the method provided in the invention, steps of generating, utilizing, and recycling the saturated vapor are well planned, so as to achieve the optimum steam cooking efficiency. Hence, if the high-pressure saturated vapor, which has more water molecules than water molecules of superheated vapor, is introduced into the normal-pressure food ingredient containing chamber, the vapor flow caused by the pressure drop may ensure the saturated vapor to be rapidly sprayed onto the food ingredient in no need of any pressurized fan nor other equipment, and before the vapor is sprayed onto the food ingredient, the vapor is still in form of saturated vapor with the latent heat, and the latent heat is immediately released after the vapor reaches the food ingredient, so that the latent heat may penetrate the food ingredient and react with water in the food ingredient. As such, the food ingredient may be cooked without being burned. In addition, by using the water vapor discharge device, the water vapor mixture that has released latent heat and is distributed in the food ingredient chamber may be effectively discharged and recycled, or the heat energy of the water vapor mixture may be recycled, so that the saturated vapor may not be blocked and may be continuously introduced and sprayed onto the food ingredient, and that the food ingredient is continuously heated by the latent heat of the saturated vapor. As such, the connective tissue of the food ingredient may be quickly and effectively destroyed on the conditions of low energy consumption, reduced cooking time, and reduction in the loss of freshness of the food ingredient, and the resulting food is soft and tender. This is different from the ordinary steam cooking.

In order to make the above and other objects, features and advantages of the invention more apparent and understandable, embodiments are provided below for detailed descriptions in conjunction with the accompanying drawings. However, those with ordinary knowledge in the field of the invention should be able to understand that the detailed descriptions and specific embodiments provided for implementation of the invention merely serve to explain the invention and do not serve to limit the scope provided in the invention.

### BRIEF DESCRIPTION OF THE DRAWINGS

FIG. 1 is a schematic view of an appearance of a steam cooking apparatus according to an embodiment of the invention.

FIG. 2 is a schematic view illustrating connections of devices of a steam cooking apparatus according to an embodiment of the invention.

FIG. 3 is a schematic view illustrating efficacy of latent heat in the invention.

FIG. 4 is a flow chart of a steam cooking method according to an embodiment of the invention.

Here, the reference numbers in the drawings are:

1 steam cooking apparatus
2 operating panel
3 door
10 food ingredient containing chamber
11 food ingredient
20 saturated vapor generating device
21 vapor chamber
22 first water tank
30 saturated vapor spraying device
40 water vapor discharge device
50 heat recycling device
51 second water tank
52 water vapor mixture discharge tube
53 pressurized pump
A point of saturated vapor
B point of saturated liquid
Qin temperature controlling heater
Q_{R} heat energy
S1, S2, S3, S4 step

### DESCRIPTION OF THE EMBODIMENTS

Hereinafter, embodiments and accompanying drawings are provided to illustrate components of the apparatus, steps of the method, and the resulting effects provided in the invention. However, the relevant components, shapes, and settings of the steam cooking apparatus shown in the drawings merely serve illustrate the technical features of the invention and should not be construed as limitations in the invention.

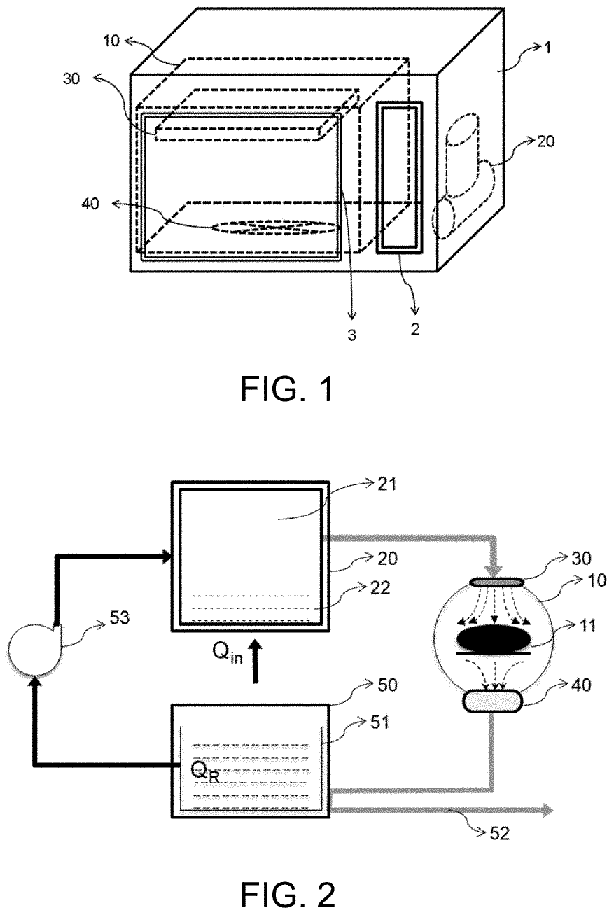

FIG. 1 is a schematic view of an appearance of a steam cooking apparatus according to an embodiment of the invention. As shown in FIG. 1, a steam cooking apparatus 1 provided in the embodiment includes: a food ingredient containing chamber 10 configured to store a food ingredient 11 and having a normal atmospheric pressure; a saturated vapor generating device 20 having a vapor chamber 21 and configured to generate and accumulate high-pressure saturated vapor with a pressure greater than the normal atmospheric pressure in the vapor chamber 21; a saturated vapor spraying device 30 communicating with the vapor chamber (not shown), having an outlet (not shown) communicating with the food ingredient containing chamber 10, and configured to release and spray the high-pressure saturated vapor to the food ingredient 11, so that when the released and sprayed saturated vapor reaches a surface of the food ingredient 11, the released and sprayed saturated vapor stays at a point of saturated vapor, and latent heat is released to the food ingredient 11 by the released and sprayed saturated vapor transformed from the point of saturated vapor to a point of saturated liquid, whereby the food ingredient 11 is heated by latent heat released from the released and sprayed saturated vapor; a water vapor discharge device 40 configured to discharge a water vapor mixture from the food ingredient containing chamber 10, so that the released high-temperature saturated vapor may be continuously applied to the food ingredient 11, and that the food ingredient 11 is continuously heated by the latent heat released from the point of saturated vapor to the point of saturated liquid. Here, the saturated vapor is transformed into the water vapor mixture when the saturated vapor releases the latent heat and reaches the point of saturated liquid, and the water vapor mixture moves toward the water vapor discharge device 40. In addition, the steam cooking apparatus 1 further has an operating panel 2 with a controller (not shown) and a door 3 for loading or unloading the food ingredient 11. In an embodiment of the invention, the steam cooking apparatus 1 further includes a heat recycling device 50 not shown in FIG. 1 but shown in FIG. 2, which will be described hereinafter.

FIG. 2 is a schematic view illustrating connections of devices of a steam cooking apparatus according to an embodiment of the invention. As shown in FIG. 2, the food ingredient containing chamber 10 has a shelf (not marked in the drawings) for placing the food ingredient 11, a saturated vapor spraying device 30 is disposed above the shelf, and a water vapor discharge device 40 is described below the shelf. An ambient pressure of the food ingredient containing chamber 10 is a normal atmospheric pressure, which is generally one atmospheric pressure (about 1 bar). The saturated vapor spraying device 30 communicates with the vapor chamber 21 of the saturated vapor generating device 20 and controls a release amount of the high-pressure saturated vapor to be released to the food ingredient containing chamber 10. Moreover, in order to expedite the high-pressure saturated vapor to reach the food ingredient 11 after the high-pressure saturated vapor is released to the food ingredient containing chamber 10 through the outlet, the distance between the outlet and the food ingredient 11 may be adjusted in an embodiment of the invention.

In addition to the vapor chamber 21, the saturated vapor generating device 20 further has a first water tank 22 located in the vapor chamber 21 and a temperature controlling heater Qin heating the first water tank 22, so that the vapor chamber 21 has and accumulates the high-pressure saturated vapor having a saturated vapor temperature corresponding to its high pressure, e.g., 2 bar at 120° C. Here, the high pressure refers to a pressure higher than the normal atmospheric pressure of 0.1 bar to 8 bar. The first water tank 22 is configured to load water and receive heat from the temperature controlling heater Qin. The temperature controlling heater Qin may be implemented in different forms. In an embodiment of the invention, the temperature controlling heater Qin may be an electric heating rod, and a heating capacity of the temperature controlling heater Qin may be adjusted according to a temperature in the vapor chamber 21, so that the temperature and the pressure in the vapor chamber 21 are maintained at 120° C. and 2 bar, respectively, i.e., in a state of high-pressure saturated vapor whose pressure is higher than the normal atmospheric pressure. According to a saturated vapor table, it is known that the saturation temperature is 120° C. when the pressure is 2 bar. Besides, in the saturated vapor state, the vapor is colorless and transparent, and the vapor quality of the saturated vapor is greater than or equal to 90%.

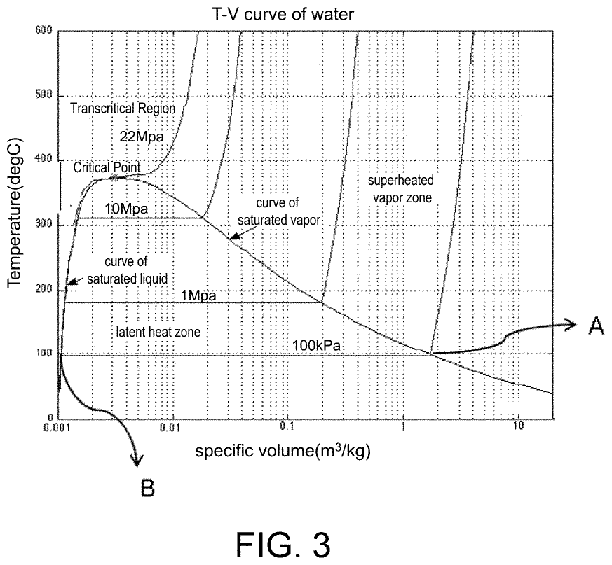

FIG. 3 is a schematic view illustrating efficacy of latent heat in the invention. As shown in FIG. 3, at 100 Kpa, i.e., at the normal atmospheric pressure of about one atmospheric pressure and 1 bar, the saturation temperature is 100° C. There is a considerable amount of the latent heat between a point A of saturated vapor and a point B of saturated liquid at 100° C., and a mixture of saturated water and vapor is referred to as water vapor or a water vapor mixture herein. At the normal atmospheric pressure, the water vapor becomes superheated vapor after exceeding the saturation temperature. Therefore, during a heating process, as long as the first water tank 22 still contains water and the vapor chamber 21 accumulates pressure, the overlying saturated vapor may be heated, and its pressure may be increased at the same time; however, the saturated vapor herein should may not be transformed into the superheated vapor. In an embodiment of the invention, a vapor storage chamber (not shown) communicating with and controlled by the vapor chamber 21 may be set to accumulate the high-pressure saturated vapor with the desired pressure and temperature.

As shown in FIG. 2, the water vapor discharge device 40 is configured to discharge the water vapor mixture whose latent heat is released in the food ingredient containing chamber 10, so that an internal environmental pressure of the food ingredient containing chamber 10 may stay at the normal atmospheric pressure even though the high-pressure saturated vapor or the released and sprayed saturated vapor is continuously introduced. Besides, a discharge amount of the water vapor mixture is controlled to correspond to a release amount of the high-pressure saturated vapor by the controller (not shown), which may be appropriately controlled by a pressure sensor. In a modified embodiment, in addition to the water vapor discharge device 40, the steam cooking apparatus 1 may further include a drainage device (not shown) at the bottom of the food ingredient containing chamber 10 to drain out or recycle the water that may be condensed.

As shown in FIG. 2, the discharged water vapor mixture is guided to a heat recycling device 50, which has a second water tank 51 for accommodating water and a water vapor mixture discharge tube 52 in the second water tank 51. The water vapor mixture discharge tube 52 communicates with the water vapor discharge device 40, so that the water vapor mixture to be discharged is not mixed with the water in the second water tank 51, and its heat energy may still be recycled into the water in the second water tank 51. The heat energy that can be recycled is marked as QR. In an embodiment of the invention, the heat recycling device 50 further includes a pressurized pump 53 configured to pressurize the water in the second water tank 51 and transfer to the saturated vapor generating device 20, which may be controlled by a controller (not shown) and may be sprayed directly into the vapor chamber 21 after pressurization, or it may be pressurized and injected into the first water tank 22 to generate the high-pressure saturated vapor. In a modified embodiment, the discharged water vapor mixture may also be directly discharged into the second water tank 51 and transformed into the water in the second water tank 51, which may be directly sent and utilized by the saturated vapor generating device 20. As such, not only the heat energy in the water vapor but also the water vapor mixture is recycled. The heat recycling process is included in the modified embodiment.

The entire connection system shown in FIG. 2 allows the high-pressure saturated vapor in the food ingredient containing chamber 10 to be reduced from 2 bar to 1 bar because of pressure release and temperature drop, and the high-pressure saturated vapor may enter the point A of saturated vapor as shown in FIG. 3. Besides, the release amount of the high-pressure saturated vapor is controlled to allow the released and sprayed saturated vapor to stay at the point A of saturated vapor when the released and sprayed saturated vapor reaches a surface of the food ingredient 11, and therefore the food ingredient 11 may be heated by the water vapor (steam) whose latent heat starts to be completely released at the embodiment, the point A of saturated vapor. Here, as shown in FIG. 3, although the superheated vapor used in the steam oven may also enter the point A of saturated vapor after the superheated vapor is cooled down, as mentioned above, in the superheated vapor state, due to the specific volume, the amount of water vapor in the superheated vapor is much lower than that in the high-pressure saturated vapor, which is not conducive to the steam cooking method.

Furthermore, in an embodiment of the invention, in addition to controlling the release amount of the high-pressure saturated vapor to be at the point of saturated vapor when the high-pressure saturated vapor reaches the surface of the food ingredient 11, it is also likely to control the release amount of the high-pressure saturated vapor and the discharge amount of the water vapor mixture, so as to keep the ambient temperature of the food ingredient containing chamber 10 to be greater than or equal to a saturated vapor temperature at the normal atmospheric pressure. Since the released and sprayed saturated vapor stays at the point of saturated vapor at the time of reaching the surface of the food ingredient 11, the latent heat may start to be effectively released at the point A of saturated vapor; if the release amount is large enough to quickly raise the ambient temperature of the food ingredient containing chamber 10 to the saturation temperature, i.e., about 100° C., even though the subsequent release amount of the high-pressure saturated vapor is reduced, and the high-pressure saturated vapor is not sprayed onto the surface of the food ingredient, the released and sprayed saturated vapor may still stay at the point of saturated vapor when the released and sprayed saturated vapor reaches the surface of the food ingredient 11, whereby the steam cooking process applying the maximum amount of the latent heat is highly effective. Practically, the release amount may be changed according to actual conditions and may vary in different stages.

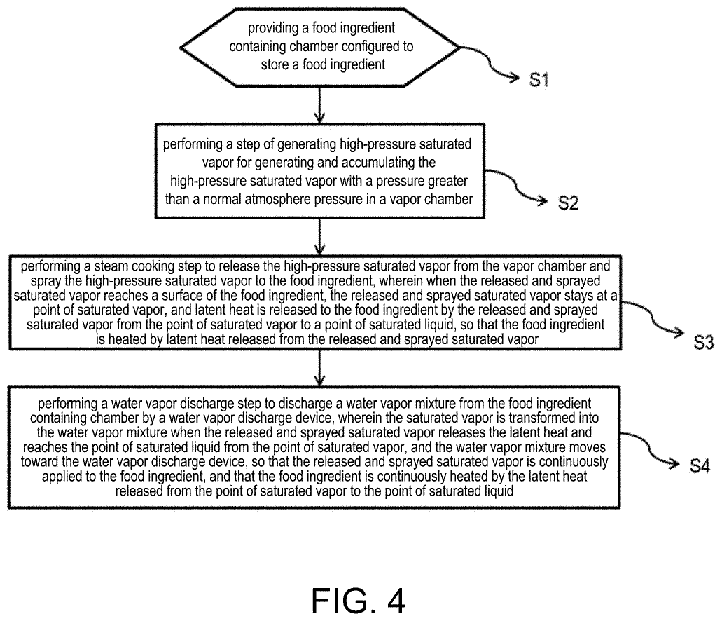

According to the foregoing embodiments, a steam cooking method as shown in FIG. 4 is also provided in an embodiment of the invention. The steam cooking method provided in an embodiment of the invention includes following steps. In step S1, a food ingredient containing chamber configured to store a food ingredient and having a normal atmospheric pressure is provided. In step S2, high-pressure saturated vapor with a pressure greater than the normal atmospheric pressure is generated and accumulated in a vapor chamber. In a steam cooking step S3, the high-pressure saturated vapor is released from the vapor chamber and sprayed to the food ingredient, so that the released and sprayed saturated vapor stays at the point of saturated vapor when the released and sprayed saturated vapor reaches a surface of the food ingredient, and latent heat is released to the food ingredient by the released and sprayed saturated vapor transformed from the point of saturated vapor to a point of saturated liquid, whereby the food ingredient is heated by the latent heat released from the released and sprayed saturated vapor. In a water vapor discharge step S4, a water vapor mixture in the food ingredient containing chamber is discharged from the food ingredient containing chamber, so that the released and sprayed saturated vapor may be continuously applied to the food ingredient, and that the food ingredient is continuously heated by the latent heat released from the point of saturated vapor to the point of saturated liquid. Here, the saturated vapor is transformed into the water vapor mixture when the saturated vapor releases the latent heat and reaches the point of saturated liquid, and the water vapor mixture moves toward the water vapor discharge device. In an embodiment of the invention, the water vapor discharge step S4 may, in consideration of the release amount of the high-pressure saturated vapor in step S3, control the release amount of the high-pressure saturated vapor and the discharge amount of the water vapor mixture, so as to keep the ambient temperature of the food ingredient containing chamber to be greater than or equal to a saturated vapor temperature at the normal atmospheric pressure, which is quite economical and cost-effective.

To sum up, the steam cooking apparatus and the steam cooking method provided in various embodiments of the invention may achieve optimum cooking efficiency and allow the food ingredient to be continuously heated by the complete latent heat of the saturated vapor; on the conditions of low energy consumption, reduced cooking time, and reduction in the loss of freshness of the food ingredient, the steam cooking apparatus and the steam cooking method with the optimum cooking effect can be applied quickly and effectively.

Lastly, it is emphasized that the components provided in the embodiments of the invention are merely exemplary and do not serve to limit the scope of the invention. Modification or substitution of other equivalent elements should also be included and covered by the scope of the invention.

What is claimed is:

1. A steam cooking apparatus, comprising:
a food ingredient containing chamber, configured to store a food ingredient and having a normal atmospheric pressure;
a saturated vapor generating device, having a vapor chamber and configured to generate and accumulate high-pressure saturated vapor with a pressure greater than the normal atmospheric pressure in the vapor chamber;
a saturated vapor spraying device, communicating with the vapor chamber and having an outlet communicating with the food ingredient containing chamber for releasing and spraying the high-pressure saturated vapor to the food ingredient, wherein when the released and sprayed saturated vapor reaches a surface of the food ingredient, the released and sprayed saturated vapor stays at a point of saturated vapor, and latent heat is released to the food ingredient by the released and sprayed saturated vapor from the point of saturated to a point of saturated liquid, so that the food ingredient is heated by the latent heat released from the released and sprayed saturated vapor; and
a water vapor discharge device, configured to discharge a water vapor mixture from the food ingredient containing chamber, so that the released and sprayed saturated vapor is continuously applied to the food ingredient, and that the food ingredient is continuously heated by the latent heat released from the point of saturated vapor to the point of saturated liquid, wherein the saturated vapor is transformed into the water vapor mixture when the saturated vapor releases the latent heat and reaches the point of saturated liquid, and the water vapor mixture moves toward the water vapor discharge device.

2. The apparatus according to claim 1, wherein a release amount of the high-pressure saturated vapor and a discharge amount of the water vapor mixture are controlled, so that an ambient temperature of the food ingredient containing chamber is maintained to be greater than or equal to a saturated vapor temperature at the normal atmospheric pressure.

3. The apparatus according to claim 1, wherein the saturated vapor generating device further comprises a first water tank located in the vapor chamber and a temperature controlling heater heating the first water tank, so that the vapor chamber has the high-pressure saturated vapor having a saturated vapor temperature corresponding to the high pressure.

4. The apparatus according to claim 1, further comprising a heat recycling device having a second water tank for accommodating water and a water vapor mixture discharge tube in the second water tank, wherein the water vapor mixture discharge tube communicates with the water vapor discharge device, so that heat energy of the discharged water vapor mixture is recycled into the water in the second water tank.

5. The apparatus according to claim 4, wherein the heat recycling device further comprises a pressurized pump configured to pressurize the water in the second water tank and transfer to the saturated vapor generating device.

6. A steam cooking method, comprising:
providing a food ingredient containing chamber configured to store a food ingredient and having a normal atmospheric pressure;
performing a step of generating high-pressure saturated vapor and accumulating the high-pressure saturated vapor with a pressure greater than the normal atmospheric pressure in a vapor chamber;
performing a steam cooking step to release the high-pressure saturated vapor from the vapor chamber and spray the high-pressure saturated vapor to the food ingredient, wherein when the released and sprayed saturated vapor reaches a surface of the food ingredient, the released and sprayed saturated vapor stays at a point of saturated vapor, and latent heat is released to the food ingredient by the released and sprayed saturated vapor transformed from the point of saturated vapor to a point of saturated liquid, so that the food ingredient is heated by latent heat released from the released and sprayed saturated vapor; and
performing a water vapor discharge step to discharge a water vapor mixture from the food ingredient containing chamber by a water vapor discharge device, wherein the saturated vapor is transformed into the water vapor mixture when the released and sprayed saturated vapor releases the latent heat and reaches a point of saturated liquid from the point of saturated vapor, and the water vapor mixture moves toward the water vapor discharge device, so that the released and sprayed saturated vapor is continuously applied to the food ingredient, and that the food ingredient is continuously heated by the latent heat released from the point of saturated vapor to the point of saturated liquid.

7. The method according to claim 6, wherein a release amount of the high-pressure saturated vapor and a discharge amount of the water vapor mixture are controlled, so that an ambient temperature of the food ingredient containing chamber is maintained to be greater than or equal to a saturated vapor temperature at the normal atmospheric pressure.

8. The method according to claim 6, wherein the step of generating the high-pressure saturated vapor further comprises heating a first water tank located in the vapor chamber, so that the vapor chamber has the high-pressure saturated vapor having a saturated vapor temperature corresponding to the high pressure.

9. The method according to claim 6, wherein the water vapor discharge step further comprises a step of recycling heat energy of the water vapor mixture into water in a second water tank through having the water vapor mixture flow through the second water tank containing the water, and the water vapor mixture is not mixed with the water in the second water tank.
